(19) United States
(12) Patent Application Publication
(10) Pub. No.: US 2024/0200455 A1
(43) Pub. Date: Jun. 20, 2024

(54) ENERGY CELL

(71) Applicant: ENG8 LIMITED, Gibraltar (GI)

(72) Inventors: Sergei Altunin, Bryansk (RU); Oleg Kulakovskii, Saint Petersburg (RU); Haslen Matthew Back, London (GB); Valeria Tyutina, London (GB)

(73) Assignee: ENG8 LIMITED, Gibraltar (GI)

(21) Appl. No.: 18/287,552

(22) PCT Filed: Feb. 21, 2022
(86) PCT No.: PCT/GB2022/050473

§ 371 Date: Oct. 19, 2023

(30) Foreign Application Priority Data
Feb. 19, 2021 (GB) 2102409.6

(51) Int. Cl. F01B 23/10; F01B 25/02; H05B 1/02; H05H 1/48

(52) U.S. Cl. CPC F01B 23/10; F01B 25/02; H05B 1/0202; H05H 1/48

(57) ABSTRACT

An energy cell comprising: a chamber for receiving a working fluid and having at least one inlet and outlet to allow working fluid(s) to flow through the chamber, at least one electrode within the chamber to apply electrical energy to the working fluid to generate plasma therein; and the energy cell further comprising: a fluid circulation system for circulating working fluid through the chamber; and a work extraction system for extracting work from fluid output from the chamber.

### FIELD OF THE INVENTION

The present invention relates to a cell containing plasma called an energy cell, that has electricity supplied to create the plasma from a high voltage power supply unit called a plasma generator.

### BACKGROUND OF THE INVENTION

Energy cells and methods of plasma generation have been proposed which comprise a cathode, an anode, and an optional stabilizing electrode, wherein the stabilizing electrode stabilises a region of plasma within a fluid, methods of plasma generation and uses thereof. Such an energy cell is described in co-pending patent application GB1917736.9, having a filing date of 4 Dec. 2019 and related applications NL2024421, filed 11 Dec. 2019 and PCT/EP2020/084425, filed 3 Dec. 2021 (the contents of each of which are incorporated herein by reference).

Further developments of the energy cell, the plasma generators and the system they are incorporated within have led to various improvements and applications for the energy cells and methods and specifically to uses of the energy cell.

### SUMMARY OF THE INVENTION

According to an aspect of the invention there is provided an energy cell comprising:
a chamber for receiving a working fluid and having at least one inlet and outlet to allow working fluid to flow through the chamber;
at least one electrode within the chamber to apply electrical energy to the working fluid to generate plasma therein; and the energy cell further comprising:
a fluid circulation system for circulating working fluid through the chamber; and
a work extraction system for extracting work from the fluid output from the energy cell.

Without being bound by any specific theory, the circulation of fluid through the chamber in accordance with embodiments is believed to enhance the efficiency of the energy cell and provide significant advantages. In particular the circulation of working fluid may allow passage of electrolytes through the plasma chamber. The skilled person may appreciate that various catalysts may be included in the working fluid. Whilst the selection of specific catalysts may optimise the efficiency of the plasma cell operation, the applicant currently believes this to be a secondary consideration with the energy conditions being more significant. In embodiments the electrical energy may be applied as high voltage pulses with a steep front. Such pulses may provide the most effective way to energise the plasma cell. The Applicant believes that the Coulomb barrier in the synthesis of micro-particles may be overcome in embodiments without creating extremely high temperatures and force fields. This may for example be as a result of the creation of high gradients of electrical energy inside the plasma zone.

The energy cell may comprise at least one working electrode and at least one stabilising electrode. The electrodes may comprise a plurality of working electrodes. A plurality of electrodes may comprise a cathode, an anode, and a stabilizing electrode. The stabilizing electrode may stabilise a region of plasma within the working fluid. The electrodes may be configured to generate either a cathode plasma or an anode plasma. The body of the chamber may be a cathode or anode.

The plasma generated in the working fluid may be in the form of one or more plasma bubbles within the fluid. The energy cell may further comprise an electromagnetic field generator for plasma position and/or shape control.

Wishing to not be bound by theory, conditions within the energy cell enable microbubbles to appear in the plasma zone that are filled with concentrated hydrogen and oxygen ions which when cavitation occurs leads to higher efficiency of release of energy from the working fluids.

In another example instead of the electrodes being immersed in a fluid such as liquid water the electrodes maybe in a gas, steam or aerosol fluid flow. This flow may be in the form of a vortex flow of fluids. This has a potential advantage in that it creates maximum consistency and surface area of the fluids and dispersion of the electrolytes and or catalysts within the fluid.

The electrolytes and or catalysts maybe added to the energy cell within the working fluid (s) or through decay of the electrodes, in particular but not exclusively the cathode, and the atoms, molecules and micro-particles that comprised the cathode being carried into the fluid steam.

Wishing to not be bound by theory the atoms, ions, molecules and microparticles may act as electrolytes and or as catalysts. The electrical discharge ionises the fluid flow and the vortex may create regions of concentrated hydrogen, oxygen and other ions which leads to higher efficiency of release of energy from the fluids. The stability of the vortex assists in the stabilisation of the plasma field.

The injection of fluids enables the cathode and other areas and components of the energy cell to be cooled.

Wishing to not be bound by theory the energy released from the working fluids may be in the form of light that is related to the physical and electromagnetic conditions on the inside of the energy cell.

The heat generated inside the energy cell maybe removed from the working fluids and or a separate cooling circuit. The body of the energy cell may be designed to maximise energy absorption and contain cooling circuits.

The dielectric properties of the working fluid maybe temperature dependent. A pre-heater installed to heat the working fluids prior to them being introduced into the energy cell enables the dielectric properties of the working fluids to be optimised. This also enables the energy efficiency of the system to be increased as the exhausted working fluids can be used to heat the input working fluids via a heat exchanger and or electric pre-heater to minimise start up time and energy.

If a mix of water and other gases are introduced into the energy cell in the form of compressed air, or an inert gas such as argon or an active gas such as carbon dioxide the conditions of and in the vortex can be optimised for plasma stability and energy release from the working fluids.

The working fluids dielectric and other properties may contribute to the plasma stability and efficiency of the energy cell. It has been found that sensors on the working fluids that measure the conductivity and content of the electrolytes and/or catalysts coupled to electrolyte and or catalyst dosing units enable the working fluid electrolytes and/or catalyst concentrations to be optimised during operations. Conversely additional water may be added to dilute the working fluids to optimise the operational conditions within the energy cell.

If a mix of water and other gases are introduced into the energy cell in the form of compressed air, or an inert gas such as argon or an active gas such as carbon dioxide the conditions of and in the vortex can be optimised for plasma stability and energy release from the working fluids.

The system energy outputs can vary by at least a factor of 2 due to inertia in the system and a range of factors that contribute to energy release from the working fluids and thus the pressure in the energy cell can increase dramatically. To even out pressure fluctuations within the energy cell a back-pressure regulator has been found to be beneficial.

In one iteration it was found that the back-pressure regulator pressure settings be manually or remote controlled enabling the precise operating pressure to be set.

The system energy outputs may vary by at least a factor of 2 due to inertia in the system due to a range of factors that contribute to energy release from the working fluids. It has been found that for safe operation of an energy cell a number of safety measures can be taken including incorporating an emergency pressure release valve, a pressure activated electrical cut out switch or a combination of both, that activate when the maximum operating pressure of the system is being approached.

When the system is being stopped or a breakage occurs in the fluid pressure delivery system the pressure inside the energy cell may become greater than the pressure in the input fluid pipes. The materials and components of the input fluid system may not be designed to operate at the temperatures found inside the energy cell. It has been found to be advantageous to include non-return valves on the input fluid input tubes to prevent damage/failure of the fluid input system.

Another method of thermal regulation of the components within the energy cell is to control not just the current but also the frequency of pulses as well as supply an AC or DC current with intermittent pulsing.

The energy cell may further comprise a source of high voltage energy coupled to the electrodes. The high voltage energy source may be an AC, DC or pulsed high voltage energy source.

The incorporation of controlling electrode(s), that maybe passive or active, enabling the shape and size of the plasma field to be controlled, leading to an optimum operating conditions and efficiency, including ionisation of the working fluids within the plasma zone(s).

The plasma maybe be ignited and maintained by one or more electrical input sources, for example one to ignite the plasma and one to maintain it. This may incorporate capacitors or a Tesla type coil for ignition and buffering of the energy fluctuations within the energy cell to stabilise the plasma field.

The system comprising the energy cell and plasma generator may contain a control system that monitors the internal and/or external conditions of the energy cell. Such a control system ensures optimum efficiency and functioning of the energy cell, including component operating temperatures and maximum plasma field efficiency.

Said system may incorporate a safety and/or security function to prevent unauthorised access and for disabling the energy cell system from inappropriate access or operations.

Said system may incorporate a mechanism for measuring the energy inputs and outputs and be incorporated into a billing system.

In one example the following electricity input ranges from a plasma generator are known to enable an energy cell to function. 6 kV, IA with pulses up to 5A, the duration of such pulses maybe between 5 and 40 us and a frequency of 40 kHz. These ranges depend on the geometry and size of the energy cell. The capacitors and or a Tesla type coil may generate short term voltages that are more than ten times greater and for ten times less duration. The capacitors and or a Tesla type coil may absorb electrical current to prevent plasma field breakdown.

The electromagnetic conditions within and around the energy cell created by the plasma field and the plasma generator generate a considerable amount of electromagnetic noise that effects the readings from the measuring instruments such as flow meters, thermocouples, antenna, working fluid dielectric sensors, optical sensors, etc. To minimise this noise being communicated to the control system a radio frequency transmitter and receiver such as a wifi link maybe installed isolating the control system from the measuring instruments. This may also be done using filters such as ferrite clamps and or potential charge signal processor(s). This may be achieved with a fibre optic connection.

It was also found in one iteration that the optical and/or electromagnetic sensors connected to the energy cell transmit information to the control unit. It was found to be preferable that the voltage, ampage and frequency of the electricity entering the energy cell is matched to the output of the photons and/or electromagnetic energy received by the sensors. This can be set up as a static operating condition or adjusted automatically by the control system.

The control unit regulates the inputs into the energy cell. If the system does not have a feedback loop there maybe overheating leading to failure or rapid aging of the cathode and other components within the energy cell.

The inertia within the system creates a lag between the sensors and the control system and this may create overheating of the cathode and other components within the energy cell. By applying a machine learning algorithm this code can anticipate conditions within the energy cell and act via the control system.

The water and other gas/fluid injection flows and pressures are actively regulated with the electrical energy entering the energy cell and the pressure being relieved via a pressure release value. A scheme of this is shown in FIG. 25.

The work extraction system may remove thermal energy from the fluid output from the energy cell.

The work extraction unit may for example incorporate an engine for converting thermal energy to torque to provide motive power or to drive an electrical generator.

The work extraction system may comprise a heat exchanger. It will be appreciated that a heat exchanger may have many practical applications and may for example be integrated into a space heating system or a refrigeration system. A multi-stage heat exchanger may be used for example a plurality of heat exchangers in series or parallel. Additionally, or alternatively the work extraction system may comprise a regulator for mass transfer of fluid.

The work extraction system may comprise a steam-based power generation system, for example a steam engine or steam turbine.

The work extraction system may include a non-contact system for energy transmission, such as an antenna; a thermoelectric cell or a photovoltaic cell incorporated into or around the energy cell. For example, the energy cell of an embodiment could be provided with an integral optical/electromagnetic transmitter including a photon source and one or more optical/electromagnetic lenses for directing the output. A photovoltaic cell, for example a cooled photovoltaic cell may then be used to receive the transmitted optical/electromagnetic energy.

The energy cell may also be used for direct work using the outputs directly such a light generation (transparent body), laser, body with lens, a mechanical body incorporating a piston, direct thrust (steam rocket), kinetic energy transfer (water jet cutting), and a combination of the above.

The energy cell maybe directly connected to a cylinder to produce work and as a cylinder itself to store energy as a thermal/pressure battery.

The energy cell may through variations of the electrochemistry produce a range of gasses including for example H2, O2, H2O2, etc that can be used to create work, store energy.

The energy cell may be a pressure vessel. The energy cell and fluid circulation system may be configured to maintain the working fluid at pressure. For example, the working fluid may be pressurised to a minimum of 100 KPa (1Bar). For example, the fluids may be pressurised to at least 10000 KPa (100 Bar), for example 50000 KPa (500Bar) or greater depending on the work the that the energy cells are to perform.

The chamber may comprise non-conductive end caps. The body and the end caps may be fabricated from dielectric materials such as glasses, ceramics and or composites.

The chamber may comprise a non-conductive or electromagnetically transparent casing, or a combination of both.

The pressure vessel may be an active electrode. The chamber in the pressure vessel may include a dielectric sleeve, tube and or dielectrics coatings and/or may comprise an insulating shroud.

The fluid circulation system may include at least one pump for pressurising the fluid prior to supply to the energy cell and/or to provide motive force to circulate fluid. The fluid circulation system may comprise a pre-heater for conditioning fluid prior to entering the energy cell. The pre-heater may use a heat-exchanger receiving heated fluid output from the energy cell.

The fluid circulation system may include a supply of fluid. The fluid may for example be water. The fluid circulation system may include a supply of fluid additives, for example a supply of catalyst (for example catalytic salts) and/or metallic ions (acting as electrolytes). The water may be distilled and/or deionized water. The additives may adjust the conductivity of the water.

The working electrodes may be flow-through electrodes. At least one inlet and outlet of the chamber may direct working fluid flow through the flow-through electrodes.

The energy cell may further comprise a controller. The controller may control the fluid flow through the chamber. The controller may (additionally or alternatively) control the energy applied to the electrodes. The controller may control the fluid flow in response to the demand for work extraction from the fuel cell. The controller may control the supply of fluid into the system and may, for example, control the concentration of additives in the fluid.

The energy cell may further comprise a pre-heater for providing external heat input to the energy cell. The controller may control the heater (for example to optimise the plasma generation).

Without being bound by theory, it is believed that in use the working fluid is heated by both direct heating and by inductive heating of the energy cell chamber. As such the plasma generation in the fluid may release energy to heat the fluid and the housing. For efficiency, the exterior of the chamber may be insulated. For protection from the environment the exterior of the energy cell maybe be insulated or provided with a mechanical vibration or shock and noise absorption system.

Initiation and stabilization of a plasma discharge in a fluid, particularly the creation of a plasma discharge in a fluid to form a two-phase gas vapor-phase and liquid-phase areas separated by an interface between two potential electrodes (i.e. the cathode and the anode), may be performed by stabilizing the interface between the gas vapor and liquid areas using the stabilizing electrode. As such, the stabilizing electrode stabilises a region of plasma discharge within the fluid. Specifically, the stabilizing electrode may stabilise an interface between the region of plasma discharge and the fluid. The stabilisation may also be achieved through the generation of specific electromagnetic conditions within the energy cell by incorporating into the energy cell casing or adding to the energy cell casing magnetic materials or electromagnetic devices. As used herein, the term “stabilise”, and analogous terms, is intended to mean that the interface between the region of plasma and the fluid is maintained in order to minimize thermal and electrical fluctuations at the interface.

The stabilizing electrode may initiate the plasma discharge, and subsequently perform a stabilizing/sustaining function by inhibiting the collapse of the discharge. The stabilizing electrode will often be positioned between the cathode and the anode. Optionally, the stabilizing electrode may be positioned on either the anode or the cathode, and, in this case, the stabilizing electrode is isolated from the cathode and/or the anode. As used herein, the term “between” is intended to be given its normal meaning in the art, referring specifically to locations where the stabilizing electrode may intercept and interact with the plasma discharge, thus allowing this electrode to perform its stabilizing function. The plasma discharge is produced between the cathode and the stabilizing electrode. Further, such configurations allow the plasma discharge to be confined between the stabilizing electrode and the cathode or anode.

The stabilizing electrode may emit charged particles, such as seed electrons, into the fluid, thereby enhancing both the initiation and sustainment of the plasma discharge.

Optionally, one or more power supply configurations may be coupled across the electrodes (i.e. the cathode, anode, or stabilizing electrode), forming a circuit. For instance, a high voltage direct current (DC) power supply may be coupled to the cathode and to the anode. Additionally, a high frequency alternating current (AC) power supply may be coupled to the cathode and to the stabilizing electrode. However, in some plasma conditions, the stabilizing electrode may be unpowered, and so not be coupled to the high frequency AC power supply. Alternatively, in some plasma conditions, the coupling between the high frequency AC power supply and the stabilizing electrode may be inactive, or periodically inactive, such that power is supplied only when a need for stabilization is detected. The initiation and stabilization process of the plasma discharge is intensified by using a high frequency high voltage spark discharge between the cathode (or anode) and the stabilizing electrode, with a current of the spark-discharge that is lower than the plasma discharge current (supplied by the DC power supply). In a related manner, the electric potential of the high-frequency high-voltage spark discharge is set higher than the electric potential of the plasma discharge at the cathode. Additionally, or optionally, the power supply to the cathode and to the anode can be either AC, DC and or of an impulse nature. Additionally, or optionally, the power supply to the stabilizing electrode can be either AC, DC or of an impulse nature.

The stabilizing electrode may adopt one of many shapes, depending on the most suitable configuration for a particular given application. For example, the stabilizing electrode may be formed in the shape of a plate, a sphere, a rod, or combinations thereof. Optionally, the stabilizing electrode may have a curved shape (e.g. a curved plate, or “bowl” shape), such as a curved semi-elliptical shape, which may be convex or concave when viewed with respect to the cathode. Equally, the stabilizing electrode may be configured to be substantially flat, square, elliptical, or parabolic. It will often be the case that shapes of generally large cross-section in two axes are selected as these facilitate the interaction with and stabilization of the plasma efficiently. As such, rods or plates are often selected.

The stabilizing electrode may be porous. For example, the stabilizing electrode may have perforations along its surface. These perforations may extend completely through the surface of the stabilizing electrode, or may take the form of surface indentations that extend only partially into the surface of the stabilizing electrode. The perforations allow the passage of charged particles and molecules within the fluid through the surface of the stabilizing electrode and out of the system to collection points.

Alternatively, the stabilizing electrode may be nonporous and solid.

Returning to the power supply configurations outlined above, a decoupling inductor may optionally be interposed between the high voltage DC power supply and the cathode or anode. The decoupling inductor acts to protect the DC power supply, by blocking alternating current and high frequency signals from reaching, and potentially damaging, the high voltage DC power supply.

Alternatively, the decoupling inductor may be interposed between the high voltage DC power supply and the anode. In principle, the decoupling inductor may be interposed at any suitable position within the circuit provided the decoupling inductor is in a series arrangement with the cathode and anode.

Additionally, and optionally, a decoupling capacitor may be interposed between the high frequency AC power supply and the stabilising electrode. The decoupling capacitor acts to protect the AC power supply, by blocking direct current associated with the DC power supply from reaching, and potentially damaging, the AC power supply. In principle, the decoupling capacitor may be interposed at any suitable position within the circuit provided the decoupling inductor is in a series arrangement with the cathode and anode. To regulate the current flowing between the cathode, anode and stabilizing electrode, various switching elements may be implemented. These switching elements may include, but are not limited to, solid state, electrovacuum and electronic switching elements.

In some embodiments an energy cell may be integrated or used in conjunction with an expansion chamber to harness and or store energy from the process.

According to another aspect of the invention there is provided an energy cell comprising:
a chamber for receiving a working fluid and having at least one inlet;
at least one electrode within the chamber to apply electrical energy to the working fluid to generate plasma therein;
a fluid supply for supplying working fluid through at least one inlet;
an outlet for exhausting plasma and working fluid;
and the energy cell further comprising:
an expansion chamber in fluid communication with the outlet and
a work extraction system associated with the expansion chamber.

The expansion chamber may for example be a chamber or cylinder of an engine. The engine may include further inlets for introducing additional fuels, such as a hydrocarbon and air, into the expansion chamber (such that the plasma from the plasma generator causes ignition of the fuel).

In some embodiments the energy cell may be formed as a modular unit which can be fitted to an engine in place of a conventional spark plug as an alternate ignition source (which may for example provide benefits in increased power output and/or efficiency). Accordingly, in some embodiments the outlet may be surrounded by an externally threaded body.

The energy cell may comprise an anode or cathode body with an anode or cathode rod inside it that creates an electrochemical reaction of the fluids, (liquids, aerosoles or gasses) injected into the chamber. This may cause a rapid increase in temperature and pressure which then expands into the expansion chamber (which may be a cylinder of the engine). The expansion may produce work by causing a crank shaft to rotate to produce torque. The working fluid injected into the plasma chamber may be water only or water and/or a hydrocarbon gas.

The plasma chamber outlet may be a tube but, in some embodiments, may be a nozzle (for example the outlet may be conical/venturi shape). Shaping the outlet as a nozzle may optimise the pressure conditions in the plasma chamber. The applicant has found that the introduction of water into the plasma chamber may increase the absorption of the electromagnetic energy and may for example transform such energy into heat that then increases the pressure of the gases in the plasma chamber that then expand into the expansion chamber.

Some embodiments of the invention may be used to provide a self-contained and transportable modular power plant. In another aspect of the invention there is provided a power plant comprising:
an energy cell having;
   a chamber for receiving a working fluid and having at least one inlet and outlet to allow working fluid to flow through the chamber,
   at least one electrode within the chamber to apply electrical energy to the working fluid to generate plasma therein, and
   a fluid circulation system for circulating working fluid through the chamber;
   a closed cycle heat exchange system comprising a steam generator coupled to the plasma chamber to use energy from the chamber to generate steam and a steam powered electrical generator.

Thus, it may be appreciated that in embodiments the self-contained power plant may use a steam power cycle in which electrical energy is input into the energy cell and work extracted using the steam powered electrical generator.

Wishing to not be bound by theory, experimental data obtained shows that the primary energy vector is the fluids that are introduced into the energy cell. The electrical energy from the plasma generator is used to ionise the working fluid(s) within the energy cell. The energy that is being released from the fluid(s) is electromagnetic in the form of photons (light) The electromagnetic and physical conditions being created within the energy cell cause the fluids to ionise and for the ions to lose energy, released as photons. This process maybe exothermic where the coefficient of performance maybe greater than one. In addition to hot fluids being released from the energy cell, hydrogen, oxygen and hydrogen peroxide are also produced. These maybe separated via a gas separator and or stored.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

In order that the invention may be more readily understood, it will be described further with reference to the Figures and to the specific examples hereinafter.

### BRIEF DESCRIPTION OF THE DRAWINGS

Embodiments of the invention may be performed in various ways, and embodiments thereof will now be described by way of examples only, reference being made to the accompanying drawings, in which:

FIG. 1 shows a schematic of a fuel cell in accordance with an embodiment of the invention;

FIGS. 2a to 2e illustrates examples of configurations for the passage of a fluid through a energy cell for use in embodiments of the invention as well as two or more plasma zones and 2e illustrating an example of an energy cell configuration with a vortex generator and flow of multiple fluids;

FIGS. 3a and 3b illustrate example configurations of a HV Pulse Power Source for use in embodiments of the invention.

FIGS. 4a to 4e show example configurations using a passive stabilizing electrode for use in embodiments of the invention:

FIGS. 5a to 5e show example configurations of using an active stabilizing electrode for use in embodiments of the invention;

FIGS. 6 to 15 show examples of electrode configurations for use in embodiments

FIGS. 16 to 20 show example configurations of energy cells;

FIG. 21 is an example of a configuration of an Energy Cell with a vortex generator.

FIGS. 22a and 22b are examples of energy cells where the photons can be converted directly into electricity or used as a light and heat source. 22b also illustrates the use of a thermoelectric outer layer or an antenna.

FIG. 23 is a schematic of a control system for use in embodiments;

FIG. 24 is a schematic of a noise filter system for use in embodiments

FIG. 25 is an example of the energy cell system with key components listed plus the radio frequency link between control system and sensors on the energy cell.

FIGS. 26A to 26C are examples of a configurations for an energy cell in accordance with an embodiment;

FIG. 27 shows a variety of configurations for energy cells;

FIGS. 28A and 28B show a miniature fuel cell unit for use in embodiments;

FIGS. 29 and 30 are examples of work extraction systems for use in embodiments;

FIGS. 31A and 31B are examples of heat exchanging configurations for energy cells for use in embodiments;

FIGS. 32A and 32B is a multi-section cell in accordance with embodiments; and

FIG. 33 is a graph showing experimental results for the heat to power ratio generated at different pressures in an experimental embodiment.

### DETAILED DESCRIPTION

Embodiments of the invention will be now described with reference to the attached Figures. It is to be noted that the following description is merely used for enabling the skilled person to understand the invention, without any intention to limit the applicability of the invention to other embodiments which could be readily understood and/or envisaged by the reader.

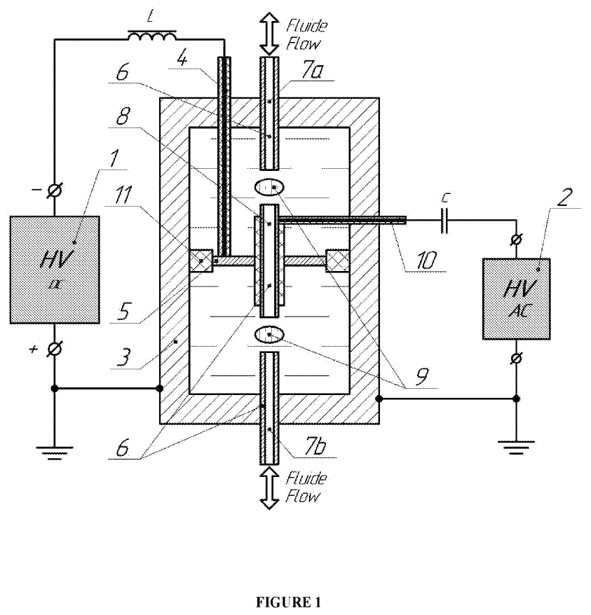

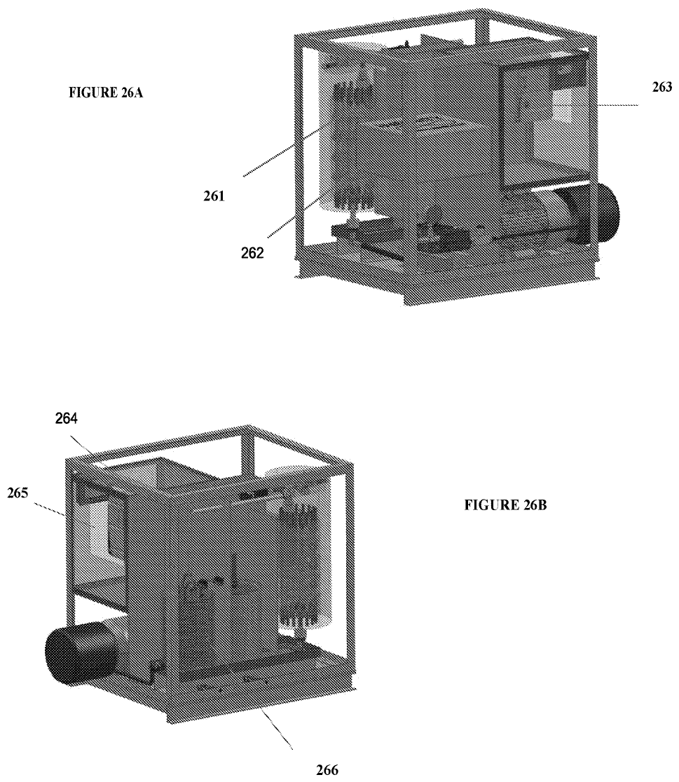

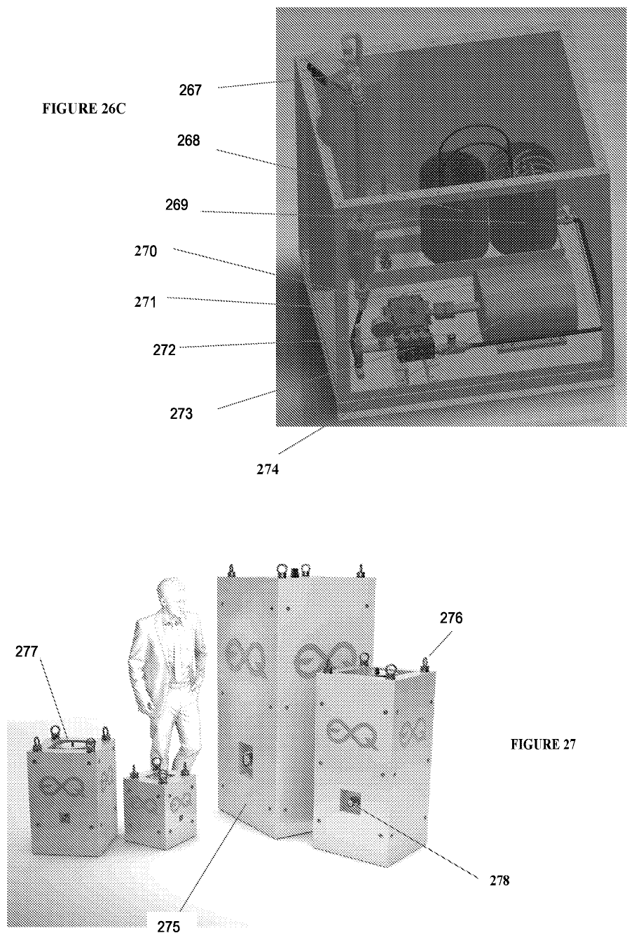

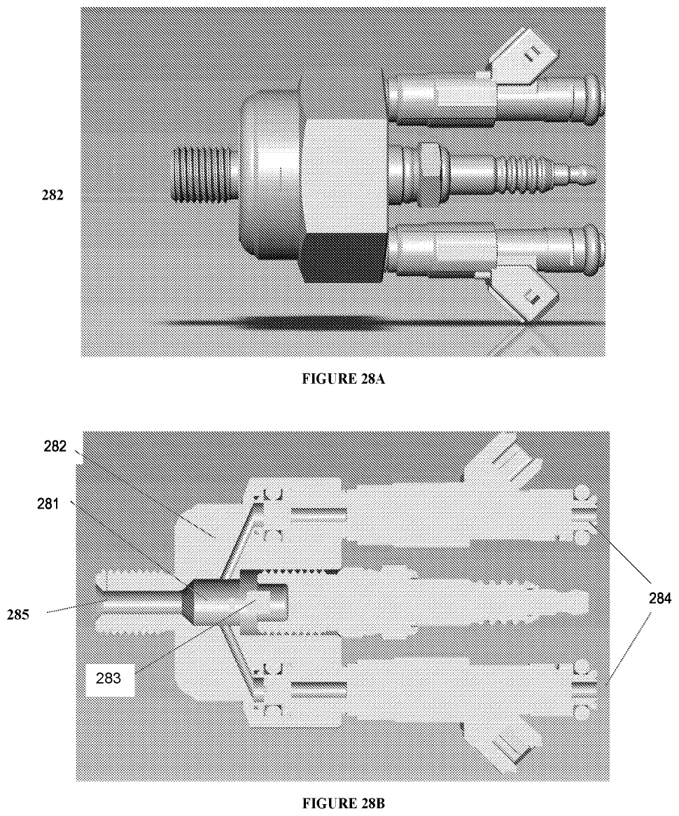

FIG. 1 illustrates an energy cell in accordance with an embodiment of the invention. The energy cell comprises an energy cell having a chamber 3 for receiving a working fluid. The chamber has at least one inlet and outlet to allow working fluid to flow through the chamber. A plurality of electrodes 5, 7a, 7b and 8 are provided within the chamber. The electrodes are connected to high voltage power supplies 1 and 2 to apply electrical energy to the working fluid to generate plasma therein. In the illustrated embodiment the first power supply 1 is connected to isolated electrode 4 and the body of the chamber 3. The second power supply 2 is connected to the isolated electrode 10 via a capacitor C and provides power to the stabilizing electrode 8. Electrodes 6 are flow-through electrodes. Electrodes 7a and 7b are anodes (but may alternatively be cathodes and are electrically connected to the body of the chamber 3. Areas of plasma as shown at 9 are generated in the chamber in use. Isolators 11 are provided for the internal electrode. The energy cell further comprising a fluid circulation system for circulating working fluid through the chamber (as indicated by “fluid flow” arrows in FIG. 1). A work extraction system is provided for extracting work from the fluid output from the energy cell. Examples of the work extraction system are described further below, for example with reference to FIGS. 26 and 27.

The energy cell operates as broadly described in the earlier application PCT/EP2020/084425. However, it is important to note the following:

In an energy cell for plasma generation, not only a cathode (cathode plasma) but also an anode (anode plasma) can be used. The plasma position and shape may also be controlled through an electromagnetic field.

The body of the energy cell 3 can be a cathode or an anode, depending on the connection circuit of the external high-voltage power supply. The energy cell housing must be safe in operation; therefore it is beneficial that it is grounded.

The main high-voltage source of electric power 1 can be direct current or alternating current and pulsed current. Also, an additional high-voltage power supply 2 for connection to the stabilizing electrode can be not only direct current, but also alternating current and pulse current.

The working electrodes of the energy cell 5, 7a and 7b and stabilising electrode 8 can be flow-through when an electric voltage is applied to them and a fluid (water, electrolyte, or other substance, including a gas or aerosol) passes through them and as an example, can have a function as a nozzle. This allows both simplification of the energy cell design and several additional advantages. For example: increase the service life of the electrodes due to their cooling and to provide better heating of the liquid circulating in the energy cell housing. The inlet and outlet of the fluid inside the housing of the energy cell can be different, for example, from the top or from the bottom, or from the top and the bottom simultaneously, or from the side, and other options and combinations of the direction of the fluid are also possible depending on the construction.

The electrodes and in particular the Cathode (s) may be made from a solid or porous material so working fluid when being introduced into the Energy Cell cools the cathode. The cathode may also be cooled using an independent cooling circuit. The cathode may be comprised of a metal alloy, a hybrid metal or a hybrid metal/ceramic or metal/glass. The specific choice of materials is intended to maximise the life of the electrode using high temperature materials for the structure and electrical conductivity and introduce into the plasma zone specific metals through ionisation/evaporation into the flow of the fluids entering the energy cell.

FIG. 1 shows that the stabilizing electrode 8 is connected to a high-voltage power supply 2. However, this power supply can be not only high-frequency alternating current, but also pulsed and direct current. There are some cases where stabilizing electrode is not powered by the additional high voltage power supply, in this case it can be excluded. When powered by direct current, the capacitor C might be excluded. Also the electrodes 7a and 7b can be connected to an AC, DC or pulsed high voltage power supply 1.

The chamber 3 may be pressurised. It has been found that the energy cell can operate more efficiently at elevated pressure (up to 500 bar and above) and, accordingly, at elevated temperatures (up to 600 degrees C. and above). This mode provides more efficient operation of the energy cell with connected devices, for example, heat engines where the exergy of the thermal transfer fluid is important for the power density of the energy cell and the devices it is connected to.

The dielectric properties of the internal fluid changes at different temperature and pressure and this effects the relationship with performance. Embodiments may include a feedback loop that optimises the electromagnetic inputs into the energy cell from the plasma generator controlled by a PLC.

The casing 3 of the energy cell can be insulated and/or isolated internally to reduce electrical losses in any possible way by using high-temperature dielectrics or coatings. Moreover, in some special cases (when using fluids, including liquids, gasses, and aerosols, one such example being made from H2O) with low electrical conductivity, less than 10 μs*S/cm), the insulation of the inner walls of the energy cell case may not be required at all. The casing 3 of the energy cell can be insulated and/or isolated externally to reduce electrical as well as thermal losses to increase the energy cell energy efficiency.

It should be noted that the body 3 of the plasma generator can be made not only of metal, but also of any other materials that meets the requirements for operation in terms of dielectric properties, temperature, pressure, and interaction with fluids, including liquids, gasses, and aerosols, one such example being H2O, heated inside. This might include the use of ceramics, glasses, composite materials, etc.

Examples of electrode configurations for use in embodiments are provided below.

It may be appreciated that the shape of anode, cathode and stabilising electrode can be varied, for example in the shape of the rod, cone, plate, tube, crown, or other geometrical figures. Various configurations are discussed further below. It is worth noting that whilst the figures are shown in a generally vertical orientation this is not essential and in practice the energy cell may take any convenient alignment in use (for example depending upon the other components of the energy cell).

Whilst the above description would provide the skilled person with a general understanding of embodiments of the invention, it may be appreciated that a range of modifications may be made and that embodiments have a wide range of potential applications. Accordingly, several key variations will now be described

### Plasma Chamber Flow

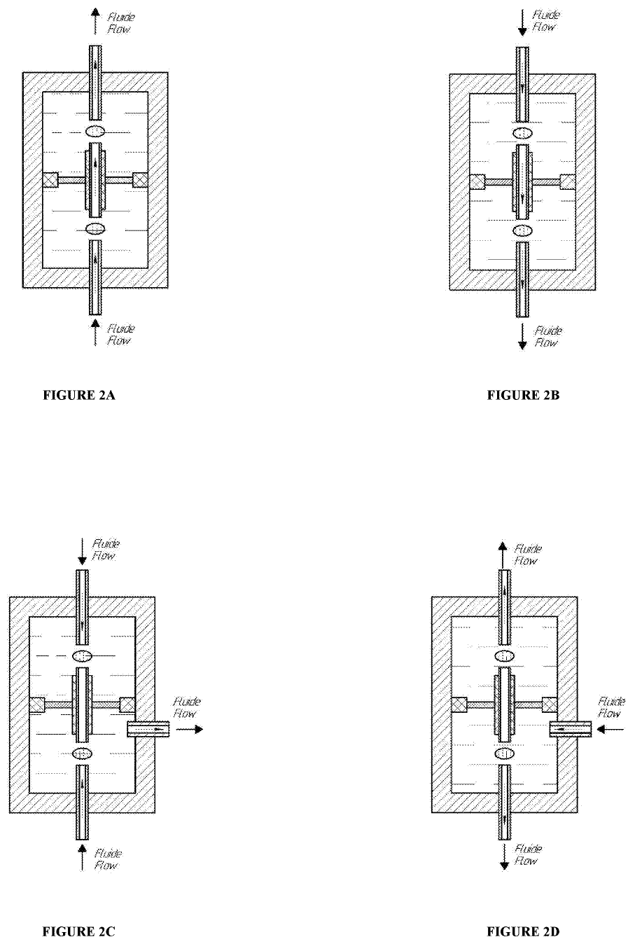

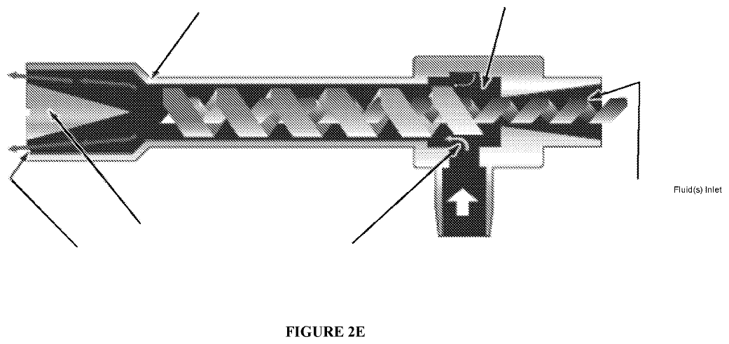

A variety of configurations for supply fluid into the energy cell through-flow electrodes are provided in the figures. Some of the possible options for the passage of a fluid through a energy cell which may be used in embodiments are shown in FIG. 2. The arrangement of FIG. 2A shows a variant of supplying fluid to the energy cell through the flow electrodes from top to bottom. The arrangement of FIG. 2B shows a variant of supplying fluid to the energy cell through the hollow electrodes from bottom to top. The arrangement of FIG. 2C shows a variant of supplying fluid to the energy cell through the flow electrodes from outside to inside. The arrangement of FIG. 2D shows a variant of supplying fluid to the energy cell through the flow electrodes from the inside out.

In FIG. 2E the fluid (s) entering the energy cell are introduced through a vortex generator, or appropriately shaped cathode, to create a vortex within the energy cell. The fluids being injected in such a way maybe as gasses, liquids, aerosols or a mixture of the aforementioned fluids.

### Power Source

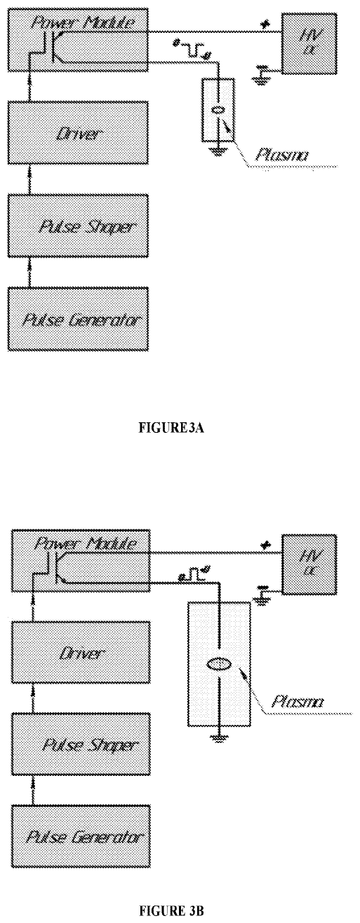

FIG. 3 shows configurations which may be used for a high voltage pulse power source in embodiments. In particular FIGS. 3A and 3B show a block diagram of the configuration of possible options for a high-voltage impulse power supply. Structurally, the two variants of a high-voltage impulse power supply differ only in the polarity of the output pulse—positive or negative with respect to the grounded electrode of the energy cell. Source block is a high voltage DC power supply that sets the parameters for the allowable voltage and current. The power switching unit Power Module, which is powered by a high-voltage DC power supply, provides the formation of pulses of a given amplitude, frequency, shape, and duration and feeds them to the electrodes of the energy cell. The driving generator Pulse Generator generates the frequency and duration of the pulses. The Pulse Shaper provides the shaping of the required pulse shape. Driver supplies the generated pulses to the power switching unit, controlling the power switches.

The presented version of a high-voltage switching power supply is capable of generating pulses up to 30 kV with amplitude currents up to 1000 A, a frequency of up to 1 MHz and a change in the duty cycle from 1 to 100%.

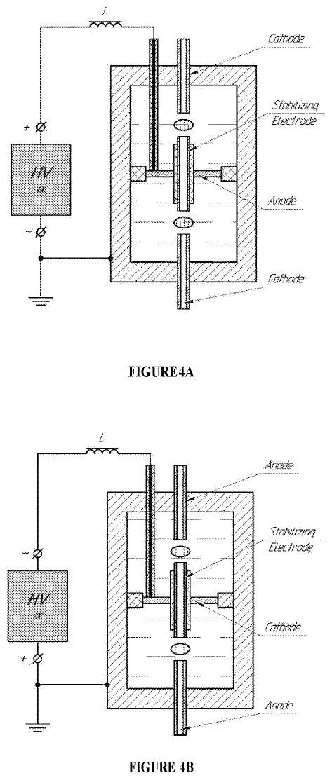

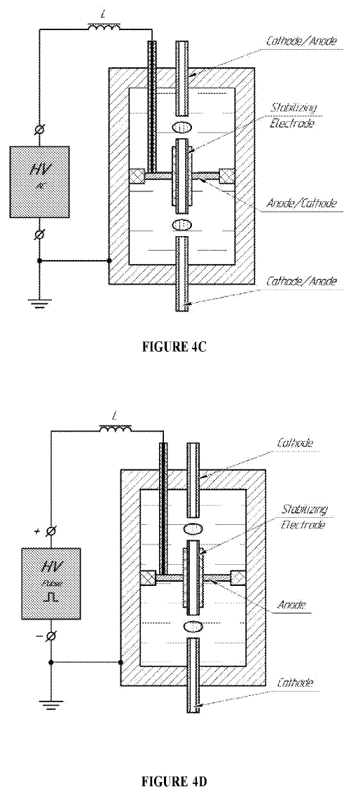

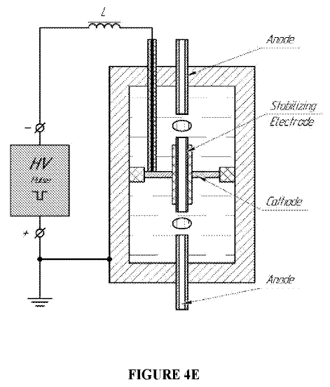

FIG. 4 shows arrangements which may be used in connecting the main high voltage power supply in embodiments. FIGS. 4A to 4E show alternate configurations having a passive stabilizing electrode. FIG. 4A shows turning on the main HV in DC mode of direct polarity, minus grounded. FIG. 4B shows turning on the main HV in the DC mode of reverse polarity, plus is grounded. FIG. 4C shows turning on the main HV in AC mode, the polarity of the electrodes change in accordance with the change in the frequency of the output voltage, one of the electrodes is grounded. FIG. 4D shows turning on the main HV in the Pulse mode of direct polarity, minus is grounded. FIG. 4E shows turning on the main HV in the Pulse mode of reverse polarity, plus is grounded.

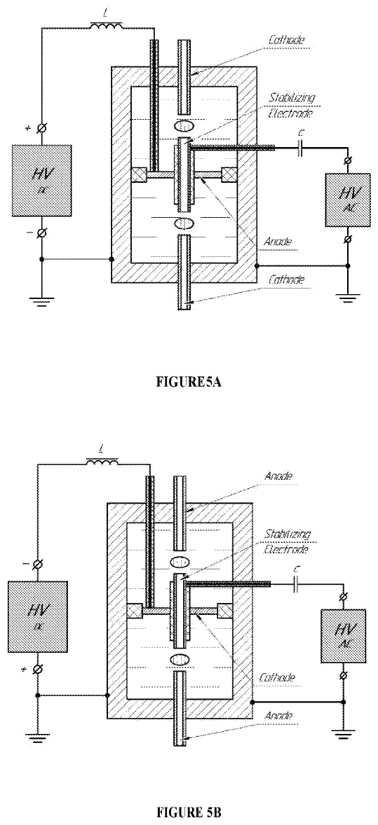

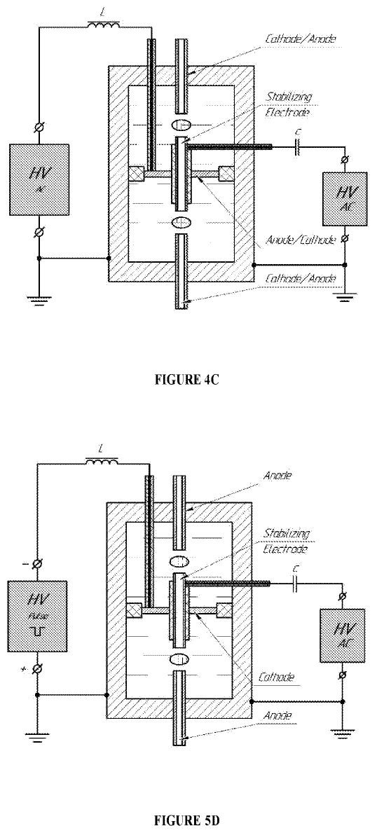

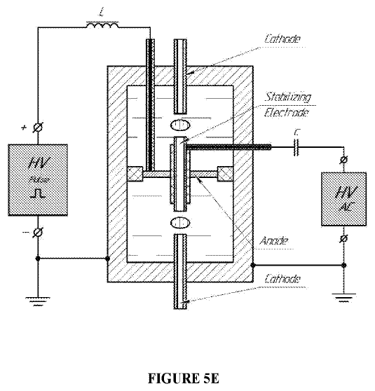

FIGS. 5A to 5E show alternate configurations using an active stabilizing electrode. FIG. 5A shows turning on the main HV in DC mode of direct polarity, minus is grounded. FIG. 5B shows turning on the main HV in the DC mode of reverse polarity, plus is grounded. FIG. 5C shows turning on the main HV in AC mode, the polarity of the electrodes change in accordance with the change in the frequency of the output voltage, one of the electrodes is grounded. FIG. 5D shows turning on the main HV in the Pulse mode of direct polarity, minus is grounded. FIG. 5E shows turning on the main HV in the Pulse mode of reverse polarity, plus is grounded; II.

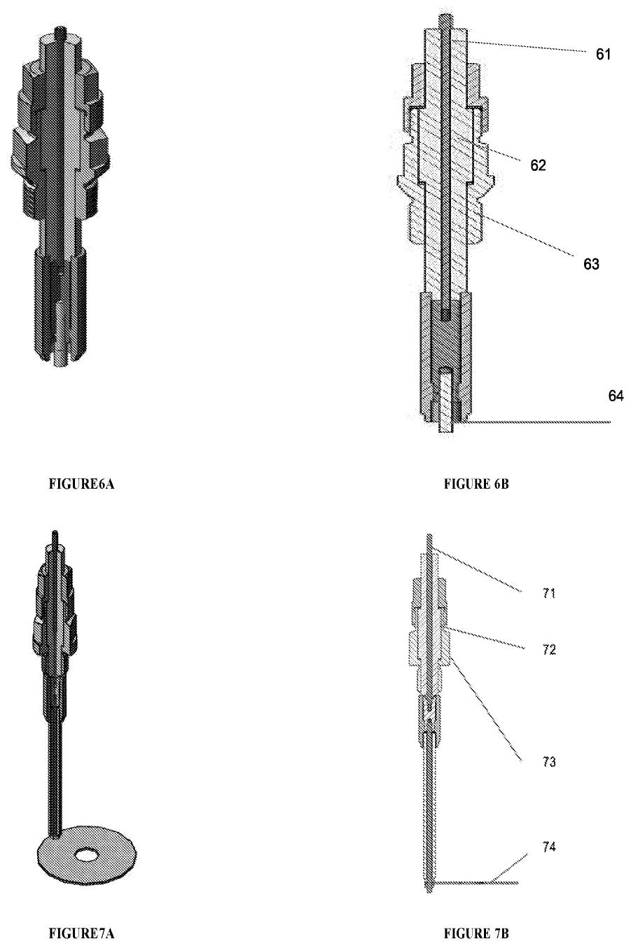

Further details of possible electrode configurations will now be discussed with reference to FIGS. 6 through 15. Various modifications of electrodes may be used in embodiments of the energy cell depending on their purpose and location. In the described variant, three types of electrodes are considered: anode, cathode, and stabilizing electrode, which can be passive (without connecting an external voltage) and active (when connecting an external voltage). In relation to the body of the energy cell, the electrodes which are used can be either electrically isolated from the body of the energy cell or electrically connected to the body of the energy cell. In addition, with respect to the inlet and outlet of the fluid from the housing of the energy cell, the electrodes can be non-flow through and flow-through (fluid can pass through them).

### Electrodes

Main requirements for the electrodes which are used are as following: the design of the electrodes must meet the requirements for operation in conditions of high temperatures, pressures, fluid inside and electrical strength when connected to high voltage. In the electrodes used, a special requirement is imposed on the materials used for dielectrics, conductive elements and working electrodes, taking into account the provision of operability at temperatures up to 600 degrees C. (and higher) and pressures up to 500 bar (and higher). In these conditions, the requirements for strength and compliance with the parameters of thermal expansion during operation are taken into account. Working elements of electrodes are made of electrically conductive and heat-resistant materials (such as, for example, tungsten), elements of working electrodes that are not exposed to high temperatures are made of materials that are most resistant to the effects of electrolytic processes (for example, titanium and its compounds).

There are numerous electrode configurations which may be used in energy cells in accordance with embodiments of the invention. A variety of such electrodes are illustrated in FIGS. 6 to 15 and are briefly outlined below. It may be appreciated that the selection of the most appropriate electrode type for any given generator may be selected based upon a variety of factors and that such optimisation could be easily carried out by those skilled in the art.

FIG. 6 shows a variant of the design of an assembled non-flow through insulated anode or cathode, as well as a stabilizing electrode. The electrode is an assembled non-flow through insulated electrode and comprises a central electrically conductive rod 61; an insulator 62; an electrode body 63 and a Cylindrical working electrode 64.

FIG. 7 is an assembled non-flow through insulated anode or cathode, as well as a stabilizing electrode. The electrode comprise a Central electrically conductive rod 71; an Insulator 72; an Electrode body 73 and a Disk shape working electrode 74.

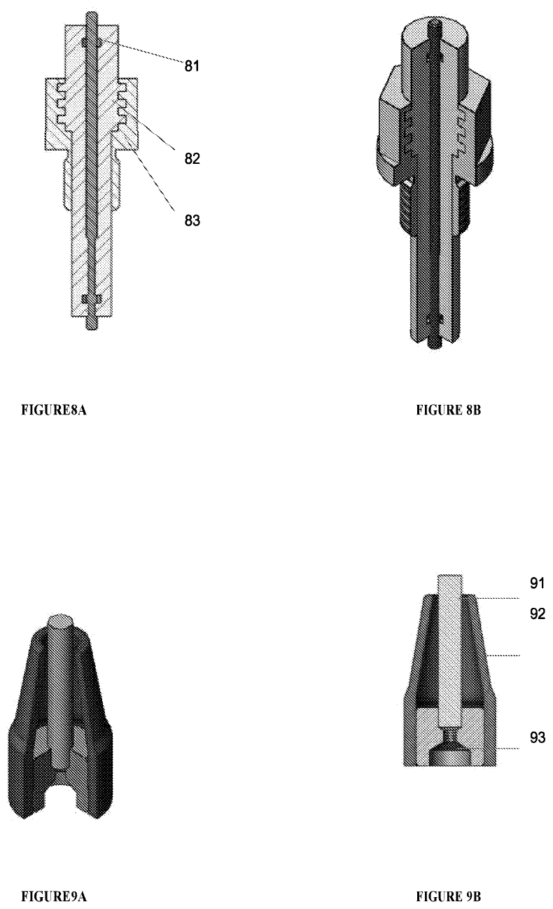

FIG. 8 is a monolithic (i.e. it cannot be disassembled) non-flow through insulated anode or cathode, as well as a stabilizing electrode. The electrode comprise a central conductive rod 81, an insulator 82 and a body 83.

FIG. 9 is a variant of the design of an assembled non-flow through non-insulated anode or cathode, as well as a stabilizing electrode with a single working rod. The electrode comprises a central electrically conductive rod 91; an Insulator 92 and an Electrode holder 93.

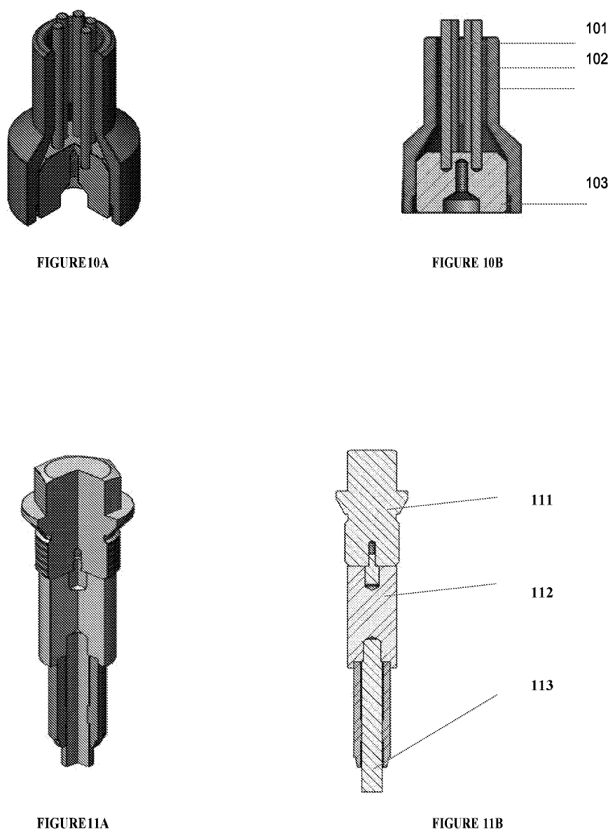

FIG. 10 is a variant of the design of an assembled non-flow through non-insulated anode or cathode, as well as a stabilizing electrode with several working rods. The electrode comprises a plurality of electrically conductive rods 101; an Insulator 102 and an Electrode holder 103.

FIG. 11 shows a design variant of an assembled non-flow through passive insulated stabilizing electrode with a cylindrical working rod. The insulated passive stabilizing electrode comprises a base of the electrode 111; an Insulator 112; an Electrode body 113 and a cylindrical working electrode 114.

FIG. 12 is a design variant of an assembled non-flow through insulated active stabilizing electrode with a cylindrical working rod. The electrode comprises a Central electrically conductive rod 121: a base of the electrode 122; an insulator 123; an Insulated electrode body 124 and a Cylindrical working electrode 125

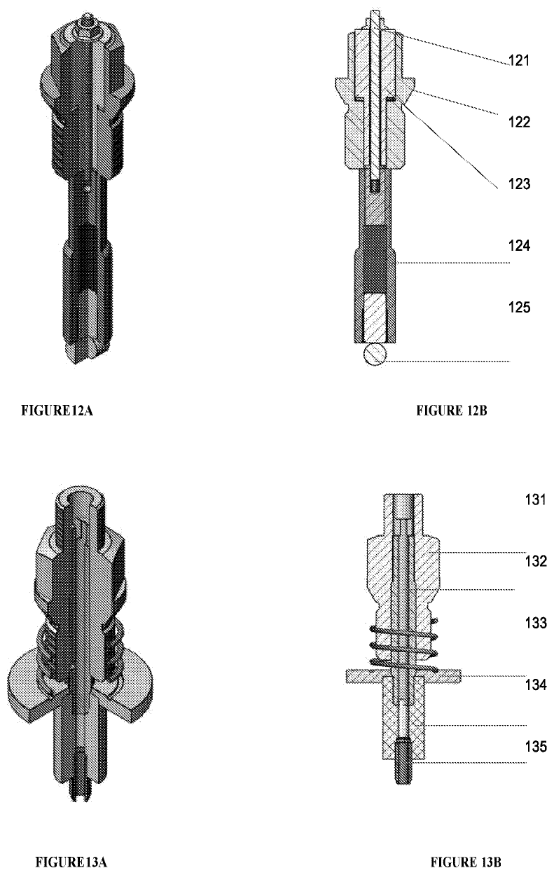

FIG. 13 is a variant of the design of an assembled flow through non-insulated stabilizing electrode with a cylindrical working rod is presented. The assembled flow-through non-insulated stabilizing electrode comprises a base 131, a Tubular electrode 132, an Insulating washer 133, an Insulator 134 and a Cylindrical working tubular electrode 135.

FIG. 14 shows a design variant of an assembled non-insulated flow-through electrode with a cylindrical working rod. The electrode comprises a base 144, an insulating washer 142, an insulator 143, a tubular electrode 144 and a cylindrical working tubular electrode 145

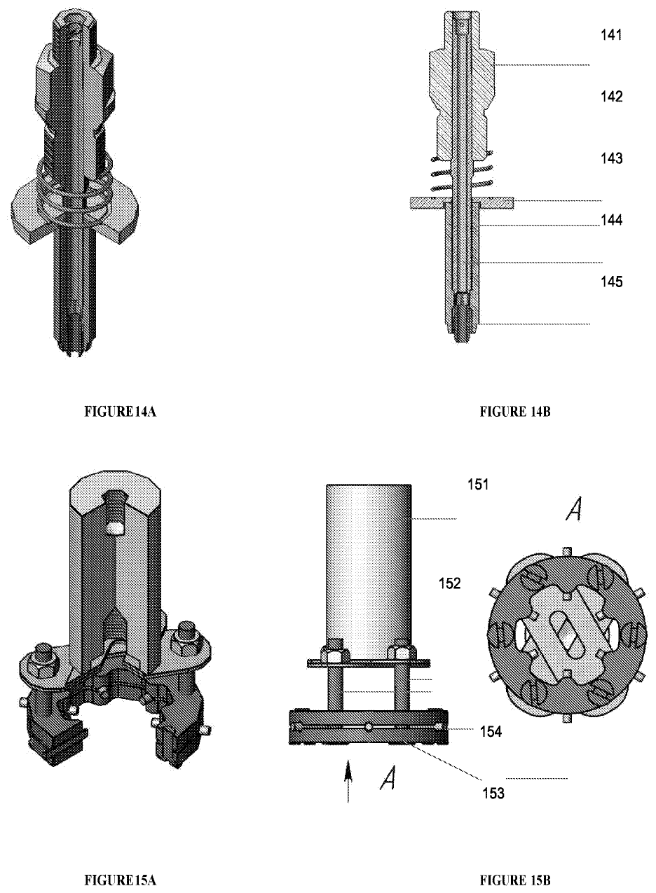

FIG. 15 shows an example of an assembled non-flowing through passive insulated stabilizing electrode with a working surface of the “crown” type. The electrode comprises an insulated base 151, a plurality of Current-carrying rods 152, a disc cage 153 and a plurality of Rod shape working electrodes 154.

### Energy Cell Configuration

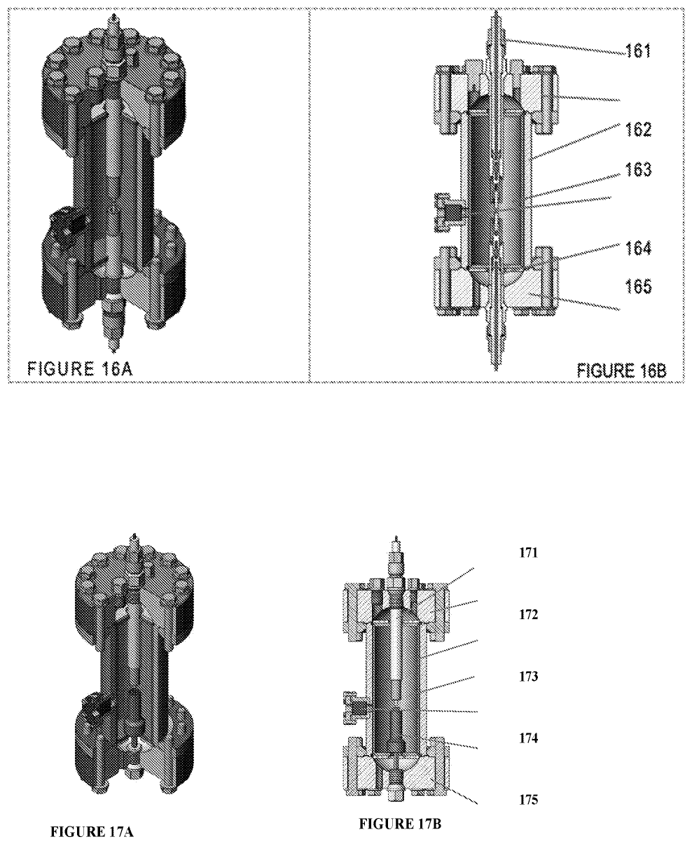

To provide further understanding of embodiments of the invention examples of energy cells for use in embodiments are shown in FIGS. 16 to 19. It may be appreciated that various designs of energy cells are possible in terms of shape, materials used, design and purpose of electrodes, technical conditions and purpose without departing from the scope of the invention.

FIGS. 16a and 16b show a design variant of a energy cell with an active stabilizing electrode at the bottom and a main electrode at the top (anode or cathode). The generator comprises a cathode (or anode) 161, a top flange 162; a body 163: a plasma chamber 164; a viewing window 165; a stabilizing electrode 166 and a bottom flange 167.

FIGS. 17A and 17B shows a design variant of a energy cell with a passive stabilizing multi-rod electrode at the bottom and a main electrode (anode or cathode) at the top. The embodiment comprises a cathode (or anode) 171; a top flange 172; a body 173; a plasma chamber 174; a viewing window 175; a stabilizing electrode 176 and a bottom flange 177.

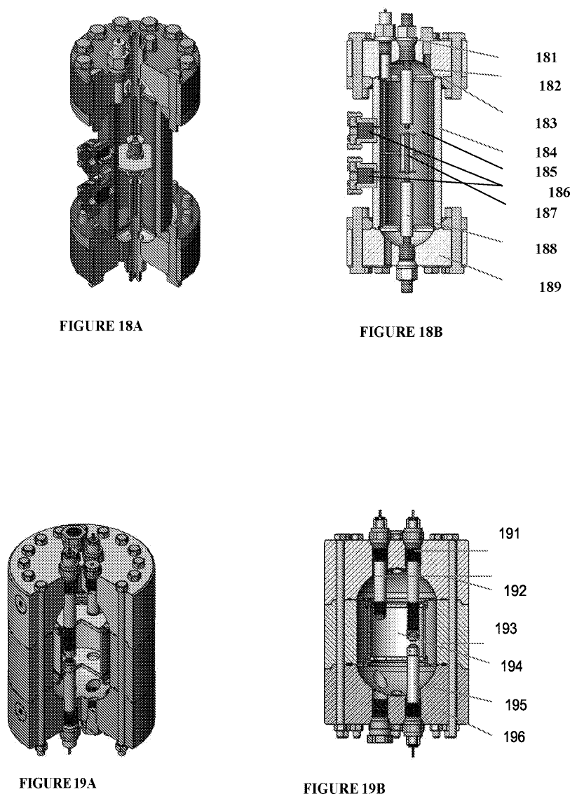

FIGS. 18A and 18B show a variant of the design of a energy cell with 2 working plasma chambers. In this design, the passive stabilizing electrode is located in the centre, between two other flow-through electrodes of the same type (either cathodes or anodes). The figure shows: flow-through cathode (or anode) 181, insulated anode (or cathode) 182; top flange 183; body 184; plasma chamber 185; viewing windows 186; stabilizing electrode 187; flow-through cathode (or anode) 188 and bottom flange 189.

FIGS. 19A and 19B shows a variant of the design of an energy cell with 2 groups of working electrodes located in one chamber. This design uses the opposite arrangement of active stabilizing electrodes and main working electrodes (anodes or cathodes). The figure shows cathode (or anode) 191; top flange 192; body 193; plasma chamber 194; stabilizing electrode 195 and bottom flange 196.

FIGS. 20a and 20b shows a variant of the design of an energy cell with a heat exchanger for transferring heat to the secondary circuit. This design uses the opposite arrangement of the main working electrode (anode or cathode) and a passive stabilizing electrode. The figure shows top flange 201; cathode (or anode) 202; body 203; plasma chamber 204; stabilizing electrode 205; heat exchanging grid 206.

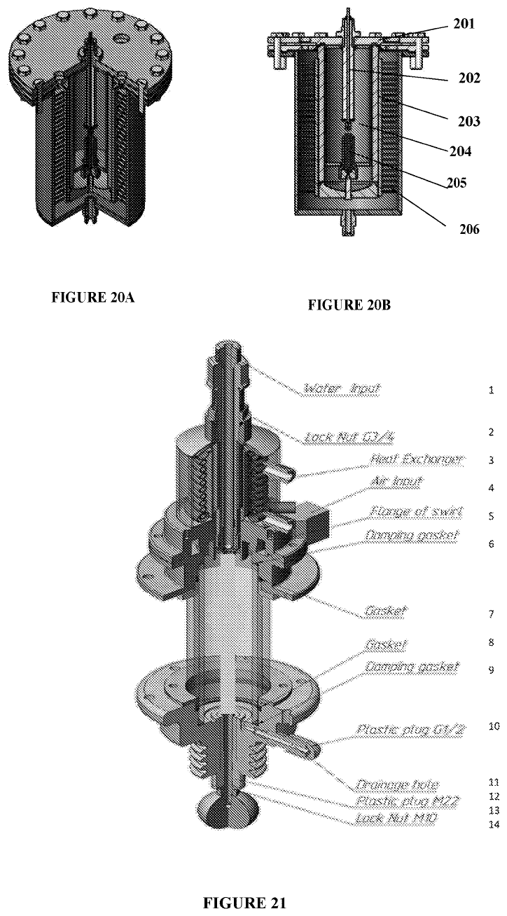

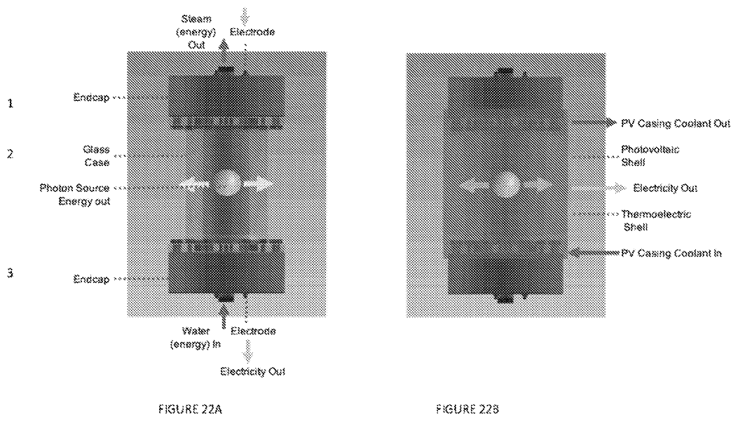

FIG. 21 shows a variant of the design of an energy cell, less a pressure and or magnetic casing, with a vortex generator and heat exchanger. 1. Is the water inlet, 2. Is a locking nut to secure the electrode. 3. Is a heat exchanger. 4. Is the air input. 5. Is the swirl or vortex generator. 6. Is a damping gasket. 7 and 8. Are gaskets. 9. Is a damping gasket. 10. Is a plastic plug. 11. Is a drainage hole. 12 & 13 Are plastic plugs. 14 is a locking not.

FIG. 22 shows a variant of the design of an energy cell with a transparent case that can be used as a heater, a light source and an electromagnetic radiation source. In FIG. 22A 1&3 are end caps. 2. Is the glass or polycarbonate, or acrylic casing. In FIG. 22B 1. Is a cooling outlet. 2. Represents a photovoltaic casing. 3. Represents a thermoelectric casing. 4. Is a coolant inlet.

### Control System

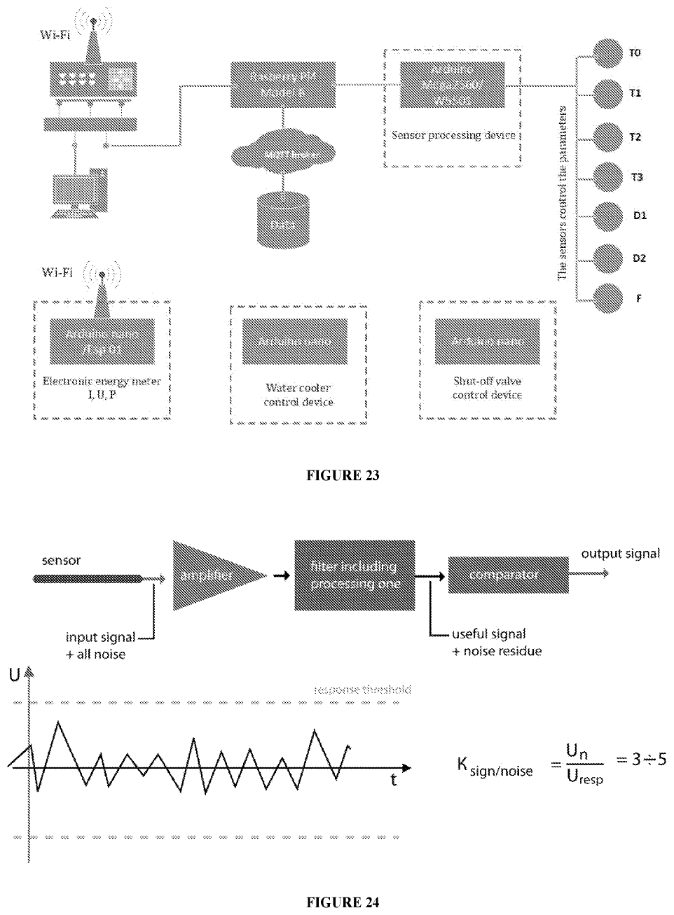

An example of a control for use in embodiments is shown in FIG. 23. The program measurement system consists of hardware and software parts. The general picture of the program measuring system is shown. The program measurement system consists of 6 modules and a main computer. Sensors for monitoring plasma fuel cell parameters consist of:
T₀-temperature sensor inside the plasma fuel cell;
T₁-water temperature sensor at the inlet of the fuel cell cooling system;
T₂-water temperature sensor at the outlet of the fuel cell cooling system;
T₃-plasma fuel cell housing temperature sensor;
D₁-pressure sensor inside the plasma fuel cell;
D₂-pressure sensor in the plasma fuel cell cooling system;
F-water flow sensor in the plasma fuel cell cooling system;

Two modules of the program measuring system work independently:
1. Water cooler control device
2. Shut-off valve control device.

These modules are designed to release hot water and steam from the system and cool it to the desired temperature and then feed it to the cooling system.

The “electric energy meter” module is located in the housing of a high-voltage power supply for a plasma fuel cell and transmits information by a wireless Wi-Fi or alternative radio communication device network. Photoelectric system or antenna may be incorporated as a means of monitoring the conditions within the energy cell.

It may be appreciated that transfer of the work from the fluid and/or thermal transfer from the fluid may be through the plasma chamber inside the energy cell, through the walls of the energy cell or around the energy cell. Such methods may enable the temperature and pressure inside and outside the energy cell to be controlled. In one variant according to an embodiment of the invention the external temperature of the energy cell may be cooled to elongate the working life of the materials the energy cell is constructed from.

Embodiments may include the incorporation of the energy cell in a system for generation of work, including; thermal energy, electrical energy, mechanical energy, electromagnetic energy, chemical energy, chemical processing and a combination of the above. Such embodiments may comprise an energy cell (or a plurality of energy cells) connected to one or more of: a torque converter; a thermoelectric cell; a Photovoltaic cell or an antenna. These may provide additional or alternate ways of powering the system and/or exporting energy from the system. Various embodiments of work extraction systems for use in embodiments will be described further below.

As the system is generally operated at a high pressure, the physical safety of the energy cell from over pressure may incorporate such devices as a gas pressure damper, pressure release valve(s) and pressure activated electronic power cut out to the energy cell and power electronics. Control of the working fluid/thermal transfer fluid maybe via a flow control value with or without a back-pressure regulator.

The inward flowing working fluid is pumped into the energy cell via a high-pressure pump that may also be used as a means of controlling the pressure inside the energy cell.

The working fluid and or thermal transfer fluid going into through or around the energy cell may pass through a preheater or a heat exchanger connected to the system to utilise waste heat from the exhaust of the work extraction system (for example the torque converter or other connected apparatus) and may include a flow control valve of the energy cell itself to optimise operating conditions inside the energy cell.

Within the system of embodiments power electronics may connected to the energy cell to produce energy in the form of electromagnetic, mechanical, chemical and or thermal.

A control system may be employed to manage the system to control the inputs and outputs to ensure the operation of the energy cell. The control may be physically or electronically connected to sensors in the system. The sensors may be configured to provide feedback inputs to the control system. Said sensors may include electromagnetic sensors that monitor the electrophysical condition of the plasma. For example, a photosensitive cell or antenna may be configured to detect the electromagnetic emissions from or in the energy cell.

FIG. 24 shows an illustration of a noise cancelling device that maybe installed between the sensors on and around the energy cell and the control system to maximise the signal to noise ratio.

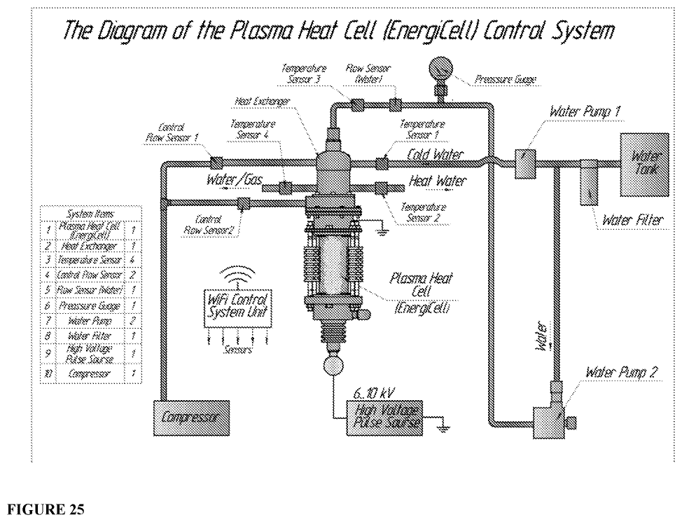

FIG. 25 is a diagram of an energy cell system that comprises of an energy cell in the middle showing the other connected components including a plasma generator supplying a high voltage pulsed current. The radio communications link, in this case a wifi one is shown to illustrate the physical disconnect between the energy cell and the control system to maximise the signal to noise ratio. 1. Is the energy cell. 2. Is a heat exchanger. 3. Shows four temperature sensors/thermocouples. 4. Shows two control flow sensors. 5. Water flow meter. 6. Pressure gauge. 7. Two water pumps. 8. Water Filter. 9. A high voltage plasma generator connected to the lowest electrode. 10. A gas compressor.

### Work Extraction System

It may be appreciated that there are a number of ways of extracting mechanical energy from the energy cell which may be used in embodiments of the invention. A variety of such embodiments will now be briefly described by way of example.

Embodiments may be connected to a torque converter such as a piston engine, a Wankel/rotary engine a turbine or a combination of the above depending on the form of mechanical energy required. Such an embodiment may include a high-pressure upstream torque converter such as a piston engine with a downstream low pressure torque converter such as a turbine.

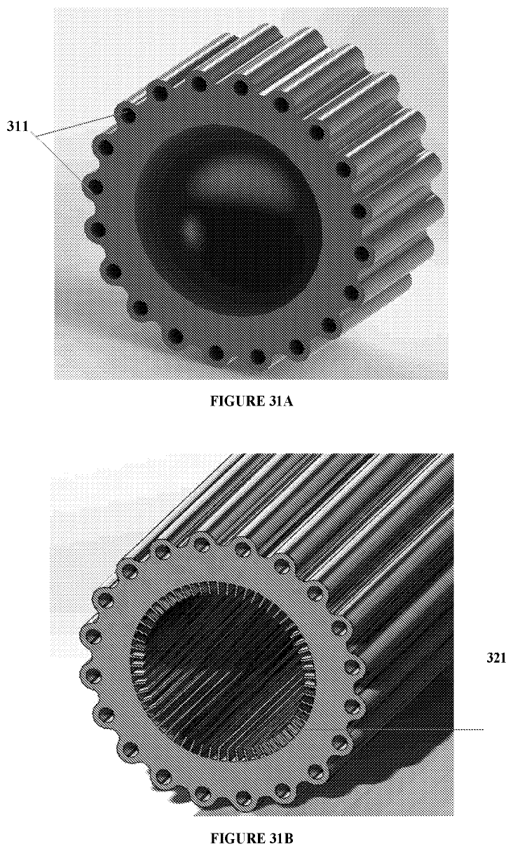

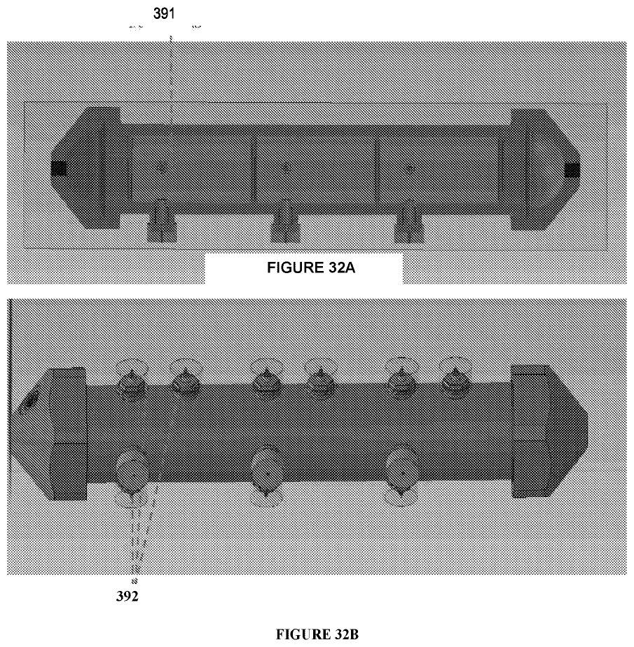

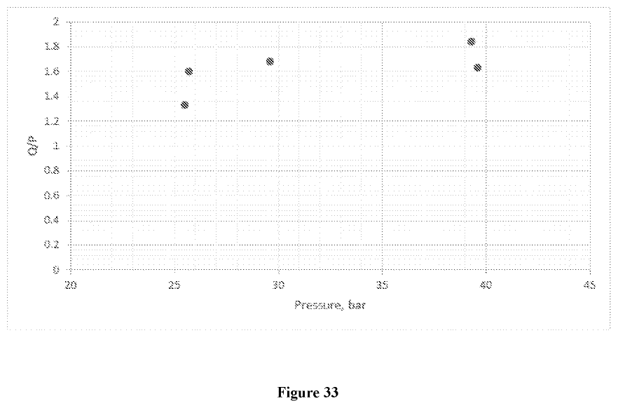

The output of thermal transfer fluid and or working fluids from the energy cell maybe be directly used to create work, or they may be passed through an external heat exchanger where the outputted thermal energy is transferred. This might be to create a phase change such as in the case of a chiller, air conditioner, etc or to create additional pressure to drive a torque converter or provide heating or a combination of the above. Examples of heat exchange configurations (which could be incorporated into the chamber of the energy cell or an output for fluid from the chamber) are shown in FIG. 31A. In each embodiment (axially directed) channels 311 are formed in the outer wall of the housing and may be supplied with a fluid such as water to extract heat from the body of the casing. In the embodiment of FIG. 31B the internal profile of the chamber is also modified to have a number of inwardly radially projecting fins 321 to encourage transfer of heat into the chamber wall. It will be appreciated that forming channels in this manner in the energy cell chamber may enable the work extraction to be directly integrated in some embodiments by extracting heat directly from the chamber wall. It will likewise be appreciated that other forms of cooling jacket around the chamber could be used in embodiments to extract work from the energy cell.

Another arrangement is shown in FIGS. 28A and 28B in which a miniature version of the fuel cell is provided comprising injectors 284 for providing a fluid flow and a body 282 defining a chamber 281 and also provides an anode. A spark plug style insulated cathode 283 is positioned in the chamber. A nozzle outlet 285 provides an outlet for working fluid from the chamber 281. Working fluid may be expelled from the nozzle into an expansion chamber to provide mechanical work extraction (for example via a piston arrangement). The shape and size of the nozzle 285 may be selected to ensure that a desired working pressure is maintained in the chamber 281 upon supply of fluid from the injectors 284. It may be noted that the outer body of the nozzle 285 is provided with an external screw thread to allow the cell to be connected to an expansion chamber in use. The external thread may be selected to match the threaded opening for a conventional spark plug in an engine cylinder head, as such the miniature fuel cell may be retro fitted to a conventional internal combustion engine with minimal modification. When used in such a configuration, the plasma and working fluid expelled from the nozzle 285 may enter the combustion chamber where upon it may both expand to work the cylinder and provide a source of heat to provide ignition of gases in the chamber (i.e. performing the function of a conventional spark or glow plug). In such an arrangement the miniature fuel cell of embodiments may provide increased power and/or efficiency to an engine.

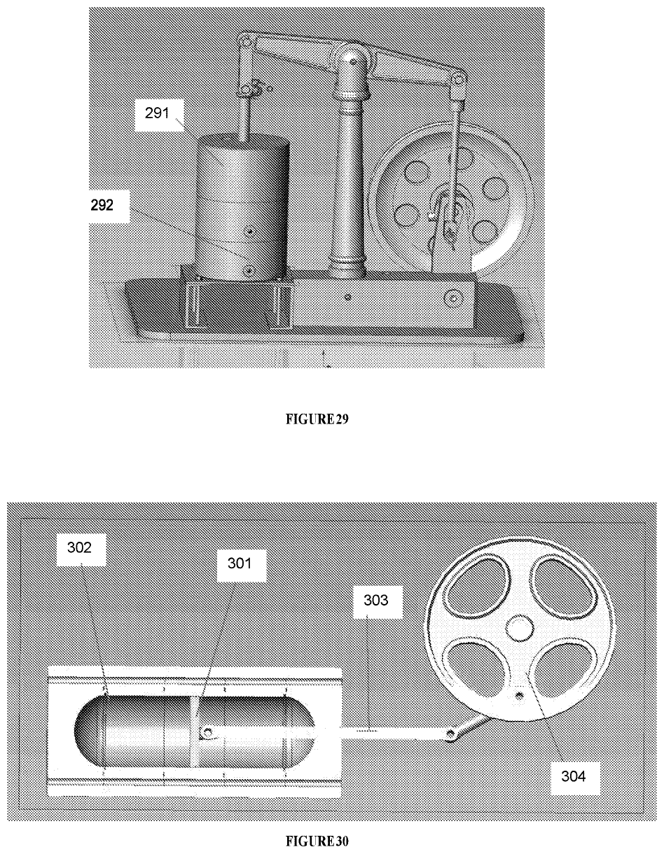

Examples of machines which can extract mechanical work from the expansion of gases are shown in FIGS. 29 and 30. It may be appreciated that such machines could either be powered directly from plasma ignition using electrodes in accordance with embodiments (for example using a miniature cell as described above) within the cylinder 291, 302 or via working fluids heated by the energy cell of embodiments. The cylinder may include ports 292 either side of a piston 301, the piston 301 being arranged to reciprocate a link rod 303 which may for example be connected to a fly wheel 304.

One way of generating additional work is to combine the output of the working fluid/thermal transfer fluid with a volatile gas. For example, the output could be combined with hydrogen. The fluid and volatile gas may be mixed with an oxygen containing gas including air and igniting it. Hydrogen and oxygen can be produced by the energy cell and fed into such a system to create work through the recombination of the gasses. Such an embodiment may provide a compact high energy cell.

The energy cell of embodiments may be used as a thermal battery/energy storage unit. Alternatively or additionally embodiments may be connected to a separate thermal battery/energy storage unit. Such arrangement can be used for starting the system and or balancing the systems internal energy requirements and or outputs. An alternator may be connected to torque converters in embodiments to create electricity for powering the said system and or exported from the system.

In some embodiments of the invention a combination of mechanical, thermal, chemical and or electrical energy can be exported from the system. An alternator may for example be used to charge a battery/energy storage unit. Such an arrangement can be used for starting the system and or balancing the system internal energy requirements and or outputs.

A number of thermal cycles can be used to extract work from the working fluids and/or the thermal transfer fluid these include the Rankin Cycle, Brayton Cycle, etc.

### Applications

The Applicant has identified a number of potential applications for embodiments of the invention which will now be briefly described.

FIGS. 29 and 230 show examples of steam engines that maybe reciprocating, rotary or turbines and maybe one two or four stroke piston engines that maybe compounded.

Energy cells maybe incorporated with said engines into a range of applications including, but not exhaustively; vehicles, electrical power generators, aircraft, marine craft.

As seen in the cross partial cut away views of FIGS. 26A to 26C, the power unit comprises a energy cell 261 and is controlled via a computer including power electronics 262, control and conditioning monitoring and billing algorithms 263 and a security system 264. A reservoir 266 is provided for the supply of liquid along with appropriate filtering systems. A flow control system 267 includes emergency pressure release valves. The flow control system allows 267 fluid to be circulated around the unit with a high-pressure pump 273 and pump motor 274 provided to pressurise and provide motive force to the flow. A condenser 268 and heat exchanger 269 are provided within the unit. The unit also includes an inward liquid reheat heat exchanger 270 a non-return valve 271 and a pressure damper 272 for the plasma chamber. It will be appreciated that with all the necessary components integrated into a single unit the plant can operate a full thermal cycle.

In some embodiments the invention may be used in or incorporated into an aircraft. Some embodiments may comprise an automobile such as a car.

In FIG. 27 several different sized energy cells are shown with protective and insulative casings 275 that have features that enable quick changing in and out of an energy cell within an energy cell system, including; quick release electrical power connectors 278 and quick release hydraulic and pneumatic connectors 277. 276 identifies lifting and manoeuvring fasteners.

A plasma cell for use in some embodiments may be arranged with multiple sections. For example FIGS. 32A and 32B shows such a cell including three partitions 391 arranged in a linear configuration within a common outer body. Each partition is provided with cathode anode and control electrode groups such as ground 392 for the first partition. One potential use for a multiple section cell is to provide purification such as desalination. For example, a substance such as sea water may be sequentially flowed from one stage to the next with salt or other contaminates precipitating out of solution and being separated. The feed through the system could for example be looped to provide a further decrease in solution chemicals.

### Experimental Validation

An experimental version of an energy cell was tested to investigate the heat to electrical power ratio(Q/P) using a prototype embodiment.

A test energy cell was provided with instrumentation and data acquisition. Thermocouple and pressure sensors were provided in the main flow. An impeller type flow meter was provided on the inlet.

The test rig was pre-heated by supplying electricity to the cell. The input electrical supply was then adjusted to form a plasma and the high-pressure water pump was started. The pump speed, electrical supply and cell pressure were adjusted to stabilise the plasma and the rig was run for around ten minutes to stabilise the temperature. The test rig was controlled open loop. The pressure set point was set using a pressure maintaining valve and the electrical supply adjusted to stabilise the plasma. The rig was then allowed to stabilise, and data was recorded without operator adjustment for a five-minute period. Analysis indicated the rig would achieve thermal stability in under one minute, so the settling period was sufficient. Tests were then performed (in order) at about 25, 40, 30, 25, 40 bar (respectively 2.5, 4.0, 3.0, 2.5, 4.0 MPa). On completion of the final 40 bar test point, the rig was shut down and cooled.

Data was recorded using a data logger at one second intervals. The data was plotted and a section at each condition where the pressure, temperatures and flow were stable for at least two minutes was selected. The data was time averaged and then processed to calculate the enthalpy rise across the rig. This was done using the ‘plasma lower’ and ‘plasma upper’ temperatures and cell pressure. At each data point Refprop, (the NIST database 23 v8.0), was used to calculate the enthalpy at the inlet and outlet of the rig. The three-phase power measurement was used for the power. The power required to drive the high-pressure pump was not measured but the ideal pump work was estimated and found to be negligible compared to the thermal power.

The resulting ratio of the enthalpy rise across the cell (Q) divided by the input electricity (P) are show in the graph of FIG. 40. As can be seen the heat to power ratio of the rig was 1.33 to 1.84 (rising with cell pressure). It will be appreciated that the test were only carried out on a prototype device and as such that it may be appreciated that the efficiency could be further improved, and the confidence of measurements may be further enhanced. However, the experiment was considered to show good proof of concept and demonstrated the successful operation of an energy cell in accordance with an embodiment running effectively and reliably.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this application. As such, the foregoing description of embodiments of the present application is not intended to be limiting. Rather, any limitations to the invention are presented in the claims.

1. An energy cell comprising:
a chamber for receiving a working fluid and having at least one inlet and outlet to allow working fluid(s) to flow through the chamber;
at least one electrode within the chamber to apply electrical energy to the working fluid to generate plasma therein;
a fluid circulation system for circulating working fluid through the chamber; and
a work extraction system for extracting work from fluid output from the chamber.

2. (canceled)

3. The energy cell of claim 1, wherein the at least one electrode comprises a cathode, an anode, and a stabilizing electrode.

4. The energy cell of claim 1, wherein a body of the chamber is a cathode or anode.

5-6. (canceled)

7. The energy cell of claim 1, wherein the work extraction system comprises an engine for converting thermal energy to provide motive power or to drive an electrical generator.

8. The energy cell of claim 1, wherein the work extraction system comprises a heat exchanger.

9. (canceled)

10. An energy cell system comprising:
a chamber for receiving a working fluid and having at least one inlet;
at least one electrode within the chamber to apply electrical energy to the working fluid to generate plasma therein;
a fluid supply for supplying working fluid through at least one inlet;
an outlet for exhausting plasma and working fluid;
an expansion chamber in fluid communication with the outlet; and
a work extraction system associated with the expansion chamber.

11. The energy cell system of claim 10, wherein the expansion chamber is a chamber or cylinder of an engine.

12. The energy cell system of claim 11, wherein the engine comprises further inlets for introducing fuel into the expansion chamber.

13. The energy cell system of claim 10, wherein the energy cell is a modular unit which can be fitted to an engine in place of a conventional spark plug.

14. (canceled)

15. A power plant comprising:
a plasma chamber for receiving a working fluid and having at least one inlet and outlet to allow working fluid to flow through the chamber;
at least one electrode within the chamber to apply electrical energy to the working fluid to generate plasma therein;
a fluid circulation system for circulating working fluid through the chamber; and
a closed cycle heat exchange system comprising a steam generator coupled to the plasma chamber to use energy from the chamber to generate steam, that is fed into a heat engine to convert the heat into torque and a steam powered electrical generator.

16. (canceled)

17. The energy cell according to claim 3, wherein the cathode comprises a pressure fitting to fasten the cathode to the energy cell case, an insulator and a conducting material fused together using an organic sealant, a glass or metal material.

18-24. (canceled)

25. The energy cell according to claim 3, wherein the cathode comprises an independent fluid cooling circuit.

26-30. (canceled)

31. The energy cell according to claim 3, wherein an electrical conductor of the cathode comprises an end component that contains elements that when eroded become a catalyst.

32-49. (canceled)

50. The energy cell according to claim 1, wherein a body of the energy cell has an outer layer that is an antenna.

51. (canceled)

52. The energy cell according to claim 1, wherein a body of the energy cell has one or more optically transparent and or electromagnetically transparent window(s) with a photosensitive and or electromagnetic sensor(s).

53. The energy cell according to claim 1, wherein a body of the energy cell is made of a dielectric ceramic.

54-55. (canceled)

56. The energy cell according to claim 1, wherein a body of the energy cell is made from less than three parts and one of the parts is made from a dielectric material.

57-62. (canceled)

63. The energy cell system according to claim 10, comprising more than one energy cell in either series or parallel.

64-65. (canceled)

66. The energy cell system according to claim 10, comprising more than one energy cell and incorporating manual or remote-controlled variable speed fluid pump(s) and or a compressed reservoir(s) of fluids with a manual or remote-controlled variable pressure release valve(s) that have a pressure sensor and or a flow meter before the fluids are introduced into the energy cell.

67. The energy cell system according to claim 10, wherein a higher-pressure circuit circulates the working fluids and a lower pressure circuit is used to extract work from the working fluids, with a heat exchanger separating the circuits.

68-73. (canceled)

74. The energy cell system according to claim 10, wherein one or more than one fluid is introduced independently or together and at the same or different quantities and velocities.

75. The energy cell system according to claim 10 incorporating a vortex generator before the energy cell or within the body of the energy cell, that creates a vortex before the working fluid are introduced into the energy cell chamber.

76-79. (canceled)

80. The energy cell system according to claim 10, comprising a measuring and dosing mechanism for electrolytes, catalysts and working fluids.

81-87. (canceled)

88. The energy cell system according to claim 10, comprising a DC power source with a with a driver, a pulse shaper and a pulse generator capacitor and or tesla type coil.

89. (canceled)

90. The energy cell system comprising the energy cell according to claim 10, comprising a high voltage DC power source and a pulse generator to supply a high voltage DC current with pulses and or intermittent pulsing.

91-92. (canceled)

93. The energy cell system according to claim 10, comprising a DC plasma generator that can control the current, voltage, ampage, the frequency of pulses as well as intermittent pulsing.

94. The energy cell system according to claim 10, comprising an automatic feedback loop controlling the input electrical signal matched to the output frequency of light and or electromagnetic radiation from the energy cell.

95. (canceled)

96. The energy cell system according to claim 10, comprising manual or remote-controlled dosing unit(s) before the fluids are introduced into the energy cell.

97. (canceled)

98. The energy cell system according to claim 10, comprising a gas damper in the form of a cylinder filled with a gas connected to the high pressure working fluids circuit before the working fluids enter the energy cell.

99. The energy cell system according to claim 10, comprising a gas absorption type heat exchanger connected to either the working fluids circuit or other thermal transfer fluids circuit(s).

100-102. (canceled)

103. The energy cell system according to claim 10, comprising a security function for disabling the energy cell from inappropriate access or operations.

104. The energy cell system according to claim 10, comprising a mechanism for measuring the energy inputs and outputs incorporated into a billing system.

105. The energy cell system according to claim 10, comprising measuring instruments such as flow meters, thermocouples, antenna, working fluid dielectric sensors, optical sensors.

106. (canceled)

107. The energy cell system according to claim 10, comprising a fibre optic link to communicate information from the sensors.

108. (canceled)

109. The energy cell system according to claim 10 and that manually or automatically controls the voltage, ampage, frequency, pulse form and gap between pulses of the electrical inputs into the energy cell based on the information from the optical and/or electromagnetic sensors.

110. The energy cell system according to claim 10 comprising machine learning capability to optimize operating conditions of the system.

111-112. (canceled)

113. The energy cell system according to claim 10, comprising coded security access to prevent unauthorized operation, wherein the coded access security is numerical or a form of a bio signature.

114. (canceled)
